(19) United States
(12) Patent Application Publication
(10) Pub. No.: US 2008/0249951 A1
(43) Pub. Date: Oct. 9, 2008

(54) SECURITY SYSTEMS AND METHODS FOR DIGITAL PAYMENTS

(76) Inventors: Clark S. Gilder, Alpharetta, GA (US); Michael G. Lalonde, Alpharetta, GA (US)

Correspondence Address: CLEMENTS BERNARD MILLER, 1901 ROXBOROUGH ROAD, SUITE 300, CHARLOTTE, NC, 28211, US

(21) Appl. No.: 11/868,335

(22) Filed: Oct. 5, 2007

Related U.S. Application Data
(60) Provisional application No. 60/850,536, filed on Oct. 10, 2006.

(51) Int. Cl. G06Q 20/00; G06Q 40/00; H04L 9/32; G06K 9/24

(52) U.S. Cl. 705/76; 705/44; 382/100

(57) ABSTRACT

The present invention provides security mechanisms for digital payments, such as a digitally originated check (DOC). The security mechanisms prevent fraud, tampering, counterfeiting, and the like of a digital payment. In an exemplary embodiment, the present invention utilizes an electronic payment system (EPS) to provide DOCs which can be utilized as Check 21 items, and which include the security mechanisms described herein to provide superior security over existing paper check-based mechanisms.

### CROSS-REFERENCE TO RELATED APPLICATION(S)

The present non-provisional patent application claims priority to U.S. Provisional Patent Application Ser. No. 60/850,536, filed Oct. 10, 2006, and entitled “FINANCIAL PAYMENT SYSTEMS AND METHODS,” the contents of which are incorporated in full by reference herein.

### FIELD OF THE INVENTION

The present invention relates generally to financial payment systems and methods, and more particularly, provides systems and methods for security algorithms designed to protect a digital check or other payment mechanisms from fraud, counterfeiting, tampering, and the like.

### BACKGROUND OF THE INVENTION

The Check Clearing for the 21st Century Act (Check 21) became effective on Oct. 28, 2004. Check 21 was designed to foster innovation in the payments system and to enhance efficiency by reducing some of the legal impediments to check truncation (eliminating a paper check by converting into a digital image and destroying the original paper item). The law facilitates check truncation by creating a new negotiable instrument called a substitute check, which permits banks to truncate original paper checks, to process check information electronically via exchange of check image files, and to deliver substitute checks to banks that want to continue receiving paper checks. A substitute check is created from a check image described by the X.9.37 ‘ANSI’ draft standard or the X9.180 final standard, both of which are incorporated in-full by reference herein. This image file is a digital bitmap in Tagged Image File Format (TIFF) created by electronically scanning and imaging the front and back of the original paper check. The substitute check (also known as an Image Replacement Document (IRD)), is created by printing the front and back images along with some additional information on an 8.5×11 inch sheet of paper. Under the Check 21 law, this IRD is treated as the legal equivalent of the original check and includes all the information contained on the original check (when printed, the images and data must conform to the X9.140 standard which is incorporated in-full by reference herein). The law does not require banks to accept checks in electronic form nor does it require banks to use the new authority granted by the Act to create substitute checks. The law also does not authorize the payor to generate their own truncated item which satisfies all of the warranties and indemnities required to be acceptable substitute checks. Thus, while the law allowed banks to truncate checks by generating electronic items, end users as payors or payees were not included in the original intent of the law nor were they conceived as being part of the truncation concept.

Referring to FIG. 1, a substitute check (or IRD) 10 is a paper reproduction of an original check that contains an image of the front and back of the original check and is suitable for automated processing in the same manner as the original check. To clear a check for consideration of payment, the depositing bank transfers, presents, or returns the substitute check 10 (or another paper or electronic representation of a substitute check) and warrants that (1) the substitute check 10 contains an accurate image of the front and back of the original check and a legend stating that it is the legal equivalent of the original check, and (2) no depositary bank, drawee, drawer, or endorser will be asked to pay a check that it already has paid. The substitute check 10 for which a bank has made these warranties is the legal equivalent of the original check for all purposes and all persons.

Although Check 21 has facilitated the inter-bank exchange of electronic check images, it has not been fully utilized or enabled throughout the payment system due to a variety of security weaknesses or legal holes that are currently viewed to be either unsolvable or to be extreme business method barriers which would need to be overcome before a wider adoption of Check 21 imaging concepts can be implemented across the payments industry. First, in terms of general Check 21 industry implementation problems, frequently both the actual paper check and the Check 21 image may be cleared by the bank creating a double debit situation. Note that while the actual number of occurrences of these double debits has been reduced as banks improve their internal Check 21 business methods and systems, these same well known debit issues are generally unavoidable for any bank first implementing a Check 21 style image clearing process for either the forward or return clearing cycles. Second, a variety of security issues are of grave concern to banks given the entire loss of the existing paper security features which have been developed over the last 30 to 40 years. These image security holes show up primarily in the banking industry when they contemplate the concept of having a customer present an image to a bank to be settled as a UCC check payment. Consider for example, the case where a customer shows up with what looks like a Check 21 image in IRD form.

As currently viewed by the industry, anyone with a modest degree of skill in digital graphics editing can create a valid Check 21-like image using PhotoShop or other graphics software programs which use stolen direct deposit account (DDA) data to create a fraudulent check. Also, given the lack of security in paper IRDs, banks are reluctant to accept random IRDs for deposit, slowing down their acceptance as returned items. Finally, banks do not believe that end users or customers are permitted under the existing Check 21 act so from the industry viewpoint, there are legal and regulatory barriers that must be overcome before Check 21 items would be viable consumer payment mechanisms. These problems must be overcome before the concepts of Check 21 can be applied to everyone—allowing more users to receive the benefits that are already being received by the banks. The benefits of image processing include lower costs from efficiently processing payments and the reduced clearing time and reduced risk exposure from unknown payor items on out of town banks. Finally, if properly implemented, the concepts provide by the Check 21 act would enable everyone from consumers to businesses to governments to charities to create and effectively process, secure electronic payments in a manner similar to existing low cost electronic payment methods such as Automatic Clearing House (ACH) items covered under the National Clearinghouse Association (NACHA) rules.

### BRIEF SUMMARY OF THE INVENTION

In various exemplary embodiments, the present invention provides security systems and methods associated with digital payments. Digital payments can include electronic Check 21 items, such as a digitally originated check (DOC), Automatic Clearing House (ACH) payments, and the like. The DOC is a fully-compliant Check 21 which is created without a paper item. The present invention provides security mechanism for digital payments, such as a digitally originated check (DOC). The security mechanisms prevent fraud, tampering, counterfeiting, and the like of a digital payment. In an exemplary embodiment, the present invention utilizes an electronic payment system (EPS) to provide DOCs which can be utilized as Check 21 items, and which include the security mechanisms described herein to provide superior security over existing paper check-based mechanisms.

In an exemplary embodiment of the present invention, a method for securing digital payments includes authenticating a payor comprising a verification of the payor's identity, creating a digital payment responsive to payment instructions from the payor, wherein the digital payment comprises security mechanisms, a globally unique identifier, and payment instructions, notifying a payee of the digital payment, providing the digital payment to the payee through secure transmission mechanisms, and cashing the digital payment.

In another exemplary embodiment of the present invention, a secure method for receiving a digital payment includes receiving a notification of a digital payment, wherein the notification comprises one of an electronic notification and a paper item comprising a Check 21 compliant substitute check printed from the digital payment, retrieving the digital payment if the notification comprises the electronic notification, determining a globally unique identifier associated with the digital payment, wherein the globally unique identifier is located in the notification, inputting the globally unique identifier in a verification system, and receiving a status of the digital payment from the verification system, wherein the status comprises validity of the digital payment.

In yet another exemplary embodiment of the present invention, a method for providing a secure image of a digital payment includes receiving payment instructions, formatting the payment instructions in a secure digital payment file, generating a secure image from the payment instructions, wherein the secure image comprises security configured to prevent tampering and counterfeiting of the image, and providing the secure image to a payee, wherein the payee is defined in the payment instructions.

### BRIEF DESCRIPTION OF THE DRAWINGS

The present invention is illustrated and described herein with reference to the various drawings, in which like reference numbers denote like method steps and/or system components, respectively, and in which:

FIG. 1 is an illustration of a substitute check (or IRD);

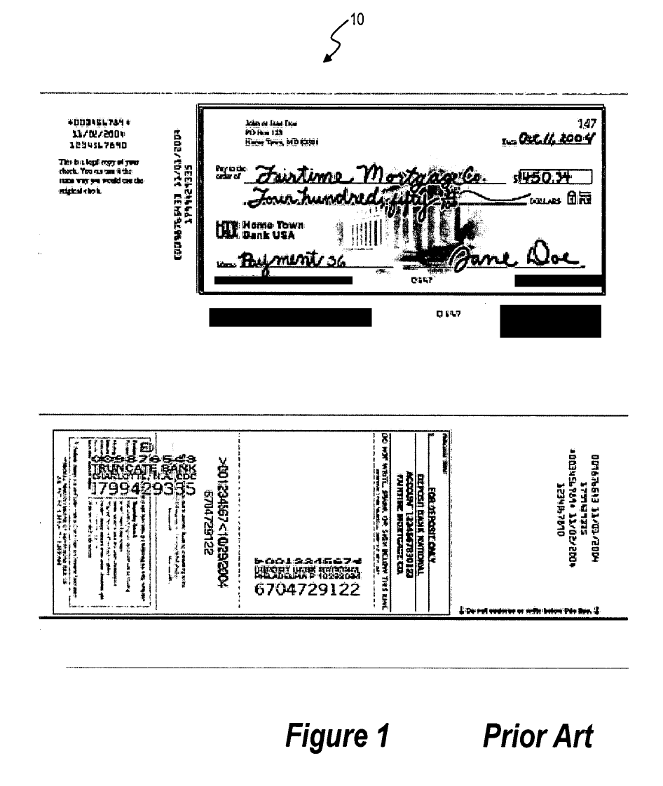

FIG. 2 is a block diagram of a digital payment file (DPF) according to an exemplary embodiment of the present invention;

FIG. 3 is a block diagram of an electronic payment system (EPS) according to an exemplary embodiment of the present invention;

FIG. 4 is a flowchart illustrating an exemplary verification mechanism according to an exemplary embodiment of the present invention;

FIG. 5 is a flowchart illustrating an exemplary DOC system with associated security mechanisms according to an exemplary embodiment of the present invention; and

FIG. 6 is a diagram of a DOC image created from the DPF according to an exemplary embodiment of the present invention.

### DETAILED DESCRIPTION OF THE INVENTION

In various exemplary embodiments, the present invention provides security systems and methods associated with digital payments. Digital payments can include electronic Check 21 items, such as a digitally originated check (DOC), Automatic Clearing House (ACH) payments, and the like. The DOC is a fully-compliant Check 21 which is created without a paper item. The present invention provides security mechanism for digital payments, such as a digitally originated check (DOC). The security mechanisms prevent fraud, tampering, counterfeiting, and the like of a digital payment. In an exemplary embodiment, the present invention utilizes an electronic payment system (EPS) to provide DOCs which can be utilized as Check 21 items, and which include the security mechanisms described herein to provide superior security over existing paper check-based mechanisms.

Compared to paper items, such as checks, digital payments, such as DOCs, have the advantage of a multi-step Authentication process. Authentication can occur at least three points during the issuance and negotiating process. First, the check issuer must authenticate to issue the check. Second, the payee must authenticate to receive and negotiate check. Further, Banks of first deposit can authenticate to guarantee funds or verify check. This provides DOCs with superior security relative to existing paper check process.

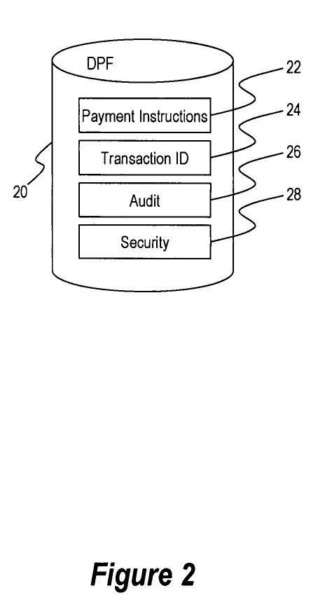

Referring to FIG. 2, a digital payment file (DPF) 20 includes payment instructions 22, a transaction identifier 24, audit information 26, and security information 28, according to an exemplary embodiment of the present invention. The DPF 20 represents a digital payment from a payor to a payee, and can include any form of payment along the various financial payment rails, e.g., check, ACH, credit card, and the like. The DPF 20 is created and store electronically, such as through an electronic payment system (EPS). For example, an EPS can include a data store, processor, and network interface all configured to interact with users for creation, distribution, and processing of the DPF 20.

The payment instructions 22 can include instructions for “whom to pay” (payee name, phone number, email address, or the like), some value amount (input as a decimal number of some currency), the payment issue date, the bank account number from which the payment is to be drafted (traditional checking account number and American Bankers Association (ABA) bank routing number), along with some potential set of conditions, limitations, or restrictions, along with memo field description details, and potentially some type of conditional acknowledgements which are defined to be business rules governing how and when the payment should be made (i.e., putting a contract on the back of a check, thus cashing the check is endorsing the contract).

The transaction identifier 24 is a globally unique identifier (GUID) which is a unique transaction identification used to identify which the DPF 20. The GUID is a special type of identifier used in software applications in order to provide a reference number which is unique in the context for which it is used, for example, in defining the internal reference for a type of access point in a software application, or for creating unique keys in a database. In the present invention, the GUID is sufficiently large to avoid object collisions, i.e. duplicate numbers, and it utilizes an algorithm to ensure GUIDs cannot be spoofed.

The audit information 26 includes the history for an audit trail of the DPF 20. Since the DPF 20 is an electronic item, it can be tracked real-time. The audit information 26 can include timestamps and associated actions, such as creation, notification of payor, payor actions associated with the DPF 20, and the like. For example, the EPS can be configured to track, i.e. record and monitor, all interaction with the DPF 20.

The security information 28 includes mechanisms designed to protect the DPF 20 from fraud, counterfeiting, and tampering. The security information 28 can include Public/Private Key Infrastructure (PKI) and Certificate authority (CAs), cryptography, steganography, Secure Socket Link (SSL), digital signatures using public and private keys, and the like. Additionally, the security information 28 can include payee and/or payor authentication requirements, such as a unique Personal Identification Number (PIN) for each DPF 20, additional levels of credentials (e.g., unique account number and login ID into the EPS), private digital security signature key (e.g., using a public key cryptography system), and the like.

The security information 28 can further include digital security features, such as digital watermarks, steganography, and cryptographic features that can be applied to the “bitmap” sent out to DOC recipients. These features apply when the DPF is converted to a paper item, such as a substitute check, or an electronic representation of a paper item (e.g., an email with an image of the substitute check). These features can be used to validate that the check was not altered. Some Digital Rights Management (DRM) features could even be “Image Survivable” meaning that they exist after an IRD printing and subsequent scanning back into an image (e.g., barcodes).

In an exemplary embodiment of the present invention, the DPF 20 represents metadata associated with a digitally originated check (DOC) which is compliant to existing Check 21 paper and electronic clearing methods. These check clearing methods can include a substitute check or Image Replacement Document (IRD) compliant to ANSI X9.37 draft as well as X9.140 IRD final standard, or an Image and Cash Letter Format file compliant to X9.180 standards. The check is referred to as a DOC due to the computer generation of the DPF 20 to distinguish it from the traditional scanning of a paper check which could be called manual or “paper origination” of a check image.

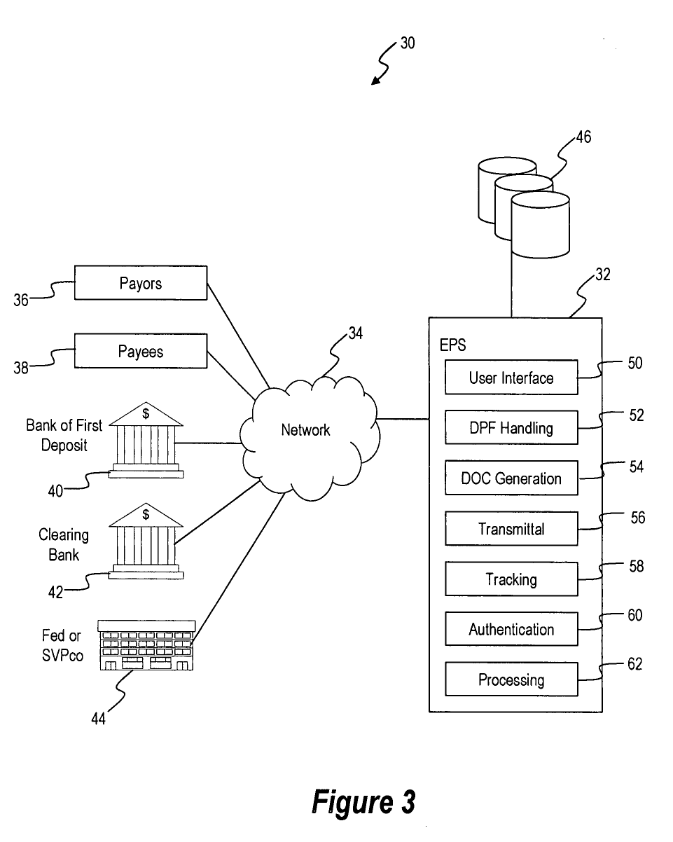

Referring to FIG. 3, an EPS system 30 is illustrated according to an exemplary embodiment of the present invention. An EPS 32 is an electronic system configured to interact with a plurality of users (e.g., payors and payees), banks, and other financial institution to enable DOC generation, distribution, tracking, authentication, security, clearing, and the like. The EPS 32 is configured to communicate over a network 34 to a plurality of payors 36, payees, 38, banks of first deposit (BOFDs) 40, clearing banks 42, clearinghouses 44, and the like. Of note, the present invention provides an anyone-to-anyone electronic payment system.

Generally, the EPS 32 is a computer system which can include multiple processing elements, distributed memory, network interfaces, external data storage 46, and the like. The EPS 32 is configured with processing and data storage redundancy, and is configured to communicate to the plurality of payors 36, payees 38, BOFDs 40, clearing banks 42, clearinghouses 44, and the like. The EPS 32 includes various modules, such as a User Interface (UI) 50, DPF handling 52, DOC generation 54, transmittal module 56, tracking module 58, authentication module 60, and processing module 62. The UI 50 provides a mechanism for users 36, 38, 40, 42, and 44 to create and distribute DOCs. Further, the UI 50 can provide mechanisms for tracking, modification, clearing, processing, security, authentication, depositing, reissuing, and the like with regards to DOCs. Also, the EPS 32 can include mechanisms for automating these processes without the need for direct UI 50 access, such as with automated processing.

The DPF handling 52 module is configured to create, modify, update, etc. of DPF records, such as the DPF 20 in FIG. 2, associated with specific DOCs. As described herein, the DPF can be a database record for storing metadata instructions related to the DOC. The EPS 32 is configured to store multiple DPFs in the data storage 46 or the like, and to enable the plurality of payors 36, payees 38, BOFDs 40, clearing banks 42, and clearinghouses 44 to create, transmit, receive, and process the DOCs associated with the DPFs. The DPF handling 52 module is configured to create DOCs responsive to user input or through automated processing. Also, the DPF handling 52 module manages tracking features, audit features, and the like described further herein. For example, because the DOC is based on metadata, it can be modified after issuance, but before final payment. This can be used for amount corrections, typing errors, and the like, when the DOC is still en-route, but not yet deposited. Similarly, the DOC can be re-issued to another party before depositing by the payee. For example, even though a payor has issued the check to one payee, the receiving party (i.e., the payee) can have the check reissued to another payee.

A unique element of an exemplary embodiment of the present invention involves the quality of the Check 21 images that are generated by the digital origination process. The DOC generation 54 module is configured to create DOC images with perfect image quality such that they pass Federal Reserve Image Quality Assessment (IQA) tests without error or corrections required. Because the “bits” or “pixels” of the DOC Check 21 image are generated from the EPS metadata, only those bits which should be “black” or “on” are enabled, eliminating background image noise, random bits or errors in the image. A DOC generated image contains only those bits which provide information as defined by the metadata; no extra or random bits are enabled in the black and white image received by the bank clearing system. Additionally, the image as seen by the payor or payee can have an optional background image, but this image is removed when it is processed by the EPS for transmission to a bank or clearing party. This optional background image allows users to have their favorite image on their check backgrounds yet avoids the well known “puppy and kitty” problem which occurs when paper items containing background images are used as input to Optical Character Recognition (OCR) algorithms which identify the amount of the payment. That is, the optional image is striped out, leaving a pure black and white image (black metadata on a white background) with no extraneous images or pixels to get in the way of further processing or image testing. Thus, because DOCs have enhanced image quality, the EPS generated DOC image can easily pass the internal depositing bank's clearing system or the Federal Reserve internal IQA tests (see e.g., www.frbservices.org/Retail/check21TechInfo.html “Black and White Image Standard and Quality Checks” document incorporated by reference herein) which measure “noise” as well as “blackness” of an imaged item. Additionally, having optimal image quality eliminates the chance for OCR errors whenever an image file is utilized as a source document for subsequent image processing. Thus DOCs can avoid the well known “copy of a copy of a copy” problem that is inherent in any paper based document processing solution.

Another unique element of the present invention involves the legal rights either created or destroyed during the Check 21 truncation process. Traditionally, Check 21 items are imaged from paper checks which have full rights and responsibilities utilized during the clearing process which are derived from either the UCC or by the Check 21 act itself (which references UCC law). Note that as passed, the Check 21 act only allows a bank to truncate the check and create a Check 21 item. Comparatively, while the DOC can be transmitted electronically, they can also be used to generate the Check 21 standard “substitute check” or IRD utilizing the X9.140 standard which results in a paper version of the original digital check. The IRD can be printed by the payee and taken into their bank for deposit because it contains a full set of warranties and indemnities based. These full set of warranties and indemnities are based on a contract agreed to by both the payor 36 and the payee 38 which the EPS 32 required to be signed in order for the DOC to sent or received. Because DOCs are covered under this contract, they have a full set warranties and indemnities that are acceptable to BOFDs 40 and downstream clearing banks 42. This novel DOC feature, i.e. DOCs possessing a “full warranty” state, differs from other attempts by either businesses or individual consumer users who want to print their own IRD documents and deposit them at a bank because those documents will not be accepted by the BOFD 40 due to the depositing bank's inability to take on un-transferable risk from an unknown originator of the IRD. This scenario is contemplated where an individual or business does not have an existing two-party private warranty contract with their bank which is a concept allowed for under existing UCC law. Also, under the Check 21 regulation as it exists today only banks can truncate checks by imaging them and later extend their warranties to subsequent clearing banks in either electronic or IRD form.

Thus, the present invention eliminates this risk by using a contract which binds the payor and payee to honor the check image or IRD and allow the bank of deposit and subsequent banks to transfer warranties and liabilities back to the responsible parties. That is, the present invention allows a bank of deposit to transfer risk back to the depositor (or the EPS 32 if it chooses to take on that risk) and if necessary all the way back to the original payor even though the payment was made in image or IRD form. The EPS system 30 facilitates this risk transference via the unique tracking identifier (GUID) and internal audit and tracking procedures along with enhanced security features all of which are bundled together in the delivery of the EPS 32 when generating and retrieving a DOC payment. Thus, the EPS system 30 can effectively measure and track their risk and know who is receiving and forwarding these payments and thus responsibly transfer this risk back to the offending party in the event of a dispute or fraudulent situation.

The DOC generation 54 module is further configured to physically print DOCs in IRD format or as normal paper checks. Further, DOCs in IRD format can automatically be regenerated back into digital form without scanning the IRD paper images utilizing the transaction ID and the EPS. Unlike traditional paper check items which are scanned and then printed in IRD format, the DOC can be re-converted back into digital form at any future date by using the unique transaction identifier (GUID). Note that the DOC check front or back image can be generated in many resolution levels (measured as dots per inch or dpi) which are independent of the chosen bitmap format, such as JPEG, TIFF, PNG, or the like. Second, a DOC image can include optional items which inform and instruct the payee as well as the depositing or clearing bank about the specific payment. Examples of this include merging a “human digitized signature” as the authorized signature directly into the front or back image of the check, even though the paperless Check 21 item was never printed or physically signed (this is accomplished under the e-signature laws using an optional and independent image layer integrated into the Check 21 image) including the statement of “Signature on File”. Note that a true, personalized “digitized signature” feature is enabled when the payor or payee has uploaded samples of their human signature or other handwriting samples (e.g., “John Q Public” as their authorized signature) into the EPS. Alternatively, the payor or payee could choose to use a font that displays in “handwriting” format to simulate their human signature. Any of these methods could satisfy the e-signature law as their authorized legal signature. Thus, the dynamic image form of a DOC file can contain valuable, optional data in both machine and human readable form without requiring paper processing. This feature further automates the processing and handling of checks and speeds up the overall business process between payor, payee and the banking system.

The notification and transmittal module 56 is configured to handle transmission of DPFs between the various payors 36, payees 38, BOFDs 40, clearing banks 42, and clearinghouses 44. As described herein, each DOC includes a GUID as a unique transaction ID associated with each DPF record. With the present invention, a bank teller could verify the legitimacy of the DOC by inputting into the EPS 32 through the UI 50 (e.g., a webpage or phone IVR system) the digits from the unique transaction identifier (GUID) which can be found on the IRD. This GUID input system is linked to the EPS 32 that originally generated the DOC for the payor, and which allowed the payee to print the IRD in the first place. The GUID value can be printed and found on the front of the IRD in the Check 21 “optional data field” location where it was placed during the DOC IRD generation process. The EPS system could check the GUID as input by the teller to acknowledge that a single, valid IRD was available for deposit (blocking attempts by unscrupulous payees to print and then deposit multiple IRDs) or consequently warning the teller not to accept the IRD because it was either an invalid GUID (for fraudulently self-created IRDs) or if the payment has already been deposited or verified.

Another exemplary embodiment of the present invention is the unique multi-part processing mechanism utilizing the electronic nature of the DOC. First, when a payor 36 sends a DOC, the EPS 32 performs multiple dynamic activities unlike the generation of either a paper check or a Check 21 item from a paper check. First, it stores the instructions to pay, and then optionally it can verify the funds are on deposit utilizing a “memo post” or ATM style verification of funds message. Second, the EPS 32 will, at the appointed time, notify the payee 38 that they have a check waiting for them (optionally, payees 38 who are well known to the EPS 32 or who are high volume receivers can have automated depositing linked to payment receipt). The notification concept is similar to getting a phone call from the bank saying that you have a check waiting for deposit. The payee can be notified by email, a voicemail, an SMS text message, an instant message or IM, a traditional pager message, or a FAX. Regardless of delivery mechanism, the payee is notified with a message to the effect that “you have money”. Third, optional business methods can be applied to the delivery and payment presentment which govern or control how the payment is to be made or received. Finally, the payee can utilize the notification method to retrieve the DOC item by utilizing the GUID to identify the specific payment waiting for them. Thus, paying by DOC provides both the notification of the payment event as well as the ability to transfer the payment value in a single or multiple process or in a manual or automated manner. This invention is unlike paper checks where two steps are mandatory (i.e., creating the value in the check, and then mailing it), the present invention can perform both in one step or with optional enhancements along the process.

Using the transmittal module 56, the teller at the BOFD 40 can request that the specific Check 21 item be re-generated as an electronic image file and be sent back into the BOFD 40 for further processing by the “Item Processing” department. To accomplish this regeneration, the EPS 32 can use the teller supplied GUID value to lookup and retrieve the specific DOC metadata information that was stored in the DPF system. As these re-creation requests arrive at the DPF, the original metadata values (or the currently stored values) are retrieved from the EPS 32 and used to re-create the digital check file in X9.37 format for further image exchange processing. This electronic X9.37 file can then be sent or routed directly back to the BOFD 40 via a secure electronic link such as the existing Federal Reserve System using the standard Cash Letter File format. The ability to re-generate at will (or at any future time) a fully compatible Check 21 digital image without scanning or handling a paper IRD is a further unique element of the present invention. The benefits of this feature are derived from the fact that the auto “regeneration” process avoids the errors of paper scanning and is a great benefit to banks in reducing the amount of labor involved in handling of paper items. Thus, there is no need to scan an IRD submitted for deposit in order to generate the front and back check image in standard Check 21 format. The regenerated image and data values can be generated directly from the EPS 32 and sent back to the BOFD 40 in a standard Cash Letter File for further image exchange processing.

The tracking module 58 is configured to provide real-time and historical tracking of each DOC created and processed through the EPS 32. The present invention allows the DOC to be generated through the EPS 32 anytime with a full history and audit trail. This is because the DOC is electronic and all interaction with the EPS 32 can be recorded, monitored, and tracked through the tracking module 58. Additionally, the DOC can still be processed locally on paper as an IRD, or it can be recreated and sent into a bank again as an electronic item at will. All of these concepts are based on the idea that the DOC is built around the metadata “instructions to pay” which are stored in the DPF and the tracking module 58 which can track the various payment steps by recording data in the DPF. The tracking module 58 provides similar information as an overnight shipment tracking feature, such as with UPS or FedEx. The DOC issuer can view real-time status related to the DOC to determine when it is received (which can also tie to an auto-notification feature), when it was cashed, if and when it is endorsed to a third party, and the like. Additionally, significant events related to the DOC can be pre-subscribed to auto notify when they occur. For example, the payor 36 can be auto-notified when the DOC is deposited or settled and cleared.

The tracking module 58 can be further configured to append authentication information whenever a DOC is touched (e.g., creation, look up, deposit, verification, clearing, etc.). This authentication information can include a PIN number, who asked for the info, time, date, data source used to validate the authenticity, Internet Protocol (IP) Trace-Route, and the like. Thus, the DOC DPF record or file has a complete audit history that contains a record of what happened to that check. Further, the EPS 32 can also track account creation, like ordering paper checks, who asked to create the DOC account, when, and the like, i.e. features at an account level or at individual item (check) level. A special privileged level of security could be required to view/see the full history, such as Home-Land Security or FBI—data can be stored in write only (no update/changes/deletes allowed) memory or history file to provide one way recording of what happened.

The authentication module 60 is configured to provide security relative to creation and processing of the DOCs. For example, the EPS 32 uses the GUID to lookup the DOC transaction and determines how to authenticate the payee based on the authentication level chosen by the payor when creating the DOC (or setup by the payee as a condition for retrieving payments from the EPS 32 under a specific name or ID). Authentication levels can include nothing (i.e., just knowing the transaction ID or GUID is enough security for the payor), or requiring a set of unique credentials (e.g., unique account number and login ID into the EPS 32 which utilizes a well known PKI method). Using private digital security signature key features (e.g., using a public key cryptography system) allows the EPS 32 to verify and identify both payor 36 or payee 38 as either originator or receiver of the DOC. Also, utilizing public key cryptographic methods allows the EPS 32 to guarantee identifies for non-repudiation all parties known to it and involved in the transaction. Either way, the there can be various levels of security agreed to by one or both parties which are supported by the EPS 32 for authentication.

The processing module 62 is configured to allow payors 36, payees 38, BOFDs 40, clearing banks 42, and clearinghouses 44 to process and clear DOCs through the EPS 32. As described herein, DOCs are identified through the GUID or the like. Once identified, the processing module 62 enables forwarding or clearing of the DOC. For example, the processing module can generate the electronic image file and send it to the bank of first deposit for further processing by the “Item Processing” department within the bank. As these re-creation requests arrive at the processing module 62, the original metadata values (or the currently stored values) are retrieved from the system and used to re-create the digital check file in X9.37 format for further image exchange processing. This electronic X9.37 file can then be sent or routed directly back to the bank of first deposit via a secure electronic link such as the existing Federal Reserve System using the standard Cash Letter File format. The regenerated image and data values can be generated directly from the EPS 32 and sent back to the bank of first deposit in a standard X9.180 Cash Letter File for further image exchange processing. Thus, this further demonstrates that any items produced by the invention are built using a fully Check 21 compliant process from electronic metadata (instructions to pay) stored in a database (DPF) instead of scanning paper or existing check image data. Since DOCs clear through system as digitally originated, they do not need Item Processing (sorting, etc.) to be cleared. All of the info needed to clear or process a check is stored in the DPF, therefore the DOC can be forwarded onto the Fed network or the clearing bank automatically by the receiver (BOFD) or any independent Check 21 image service which performs the Electronic Payments Clearing House functions (EPCH).

Additionally, another unique element of an exemplary embodiment of the invention enables the EPS 32 to provide a more efficient mechanism for stop payment of DOCs. Canceling a paper check is inconvenient and often not mandatory. For example, the payor has to go down to the bank, sign a form, and hope to catch the check in time. With a DOC, the payor can cancel it immediately, or put it on hold, etc. through the EPS 32. Also, the payor can permanently void the DOC, and a new GUID would be issued if the check is re-issued. Advantageously, this allows the payor to know if a DOC is canceled prior to issuing another in replacement. It's fast, easy and immediate—features that allow check payments to better compete with the other electronic payment clearing mechanisms under the NACHA ACH system.

Another unique element of an exemplary embodiment of the invention involves the EPS 32 and the processing module 62 utilizing the unique, automatically generated payor Positive Pay Database (PPD). Traditionally, only corporate customers who have a Treasury Management account feature tied to their high value business DDA account have been able to tell the banks which checks to pay and which ones not to pay (i.e., positive or negative pay lists). The Positive Pay Database (PPD) is an automatic feature of DOC creation, i.e. we know it was created, therefore we know which “checks” to pay, only authenticated & genuine issued DOCs can be cleared, thus consumers have PPD features that businesses have had for years. This in an internal PPD, and the EPS 66 also has the ability to send DOC creation info (PPD) out to a clearinghouse (EPCH) so that external users can verify a good check (e.g., the bank won't tell external receivers PPD info but we can with our PPD feature). External PPD info can also be issued from financial accounting software to the EPCH. Use of strong security and non-repudiation mechanisms provided by public key cryptographic systems can provide an additional level of security, audit and tracking features to DOCs. Note that once a DOC is issued and possibly digitally signed by a payor there is an automatic Positive Pay Database feature established. Whenever a check needs to be verified before it can be issued as an IRD or cleared, at a minimum the EPS 32 can use the check number, GUID or Transaction code provided to it and compare it to the known values stored in the DPF. Having additional levels of security allows even stronger levels of authentication and verification to occur. But at a minimum, the EPS 32 can use the GUID to see if it the requested item is indeed a valid DOC and also verify that it has not already been cleared. Thus, under ideal conditions involving PKI and secure authentication methods, one and only one DOC will clear as a payment.

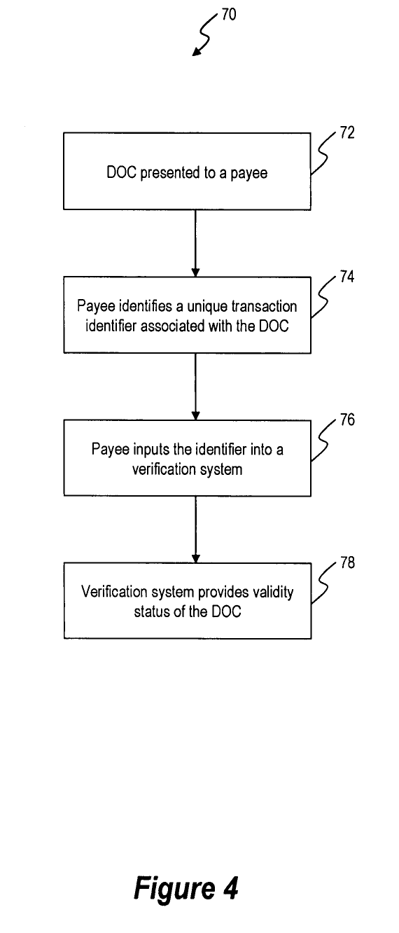

Referring to FIG. 4, a flowchart illustrates an exemplary verification mechanism 70 according to an exemplary embodiment of the present invention. Once a DOC is delivered to a payee, the verification mechanism 70 allows the payee to determine the validity of the DOC. Additionally, the verification mechanism 70 can be utilized to provide additional data, such as whether the account from which the DOC is drawn holds sufficient funds, and the like, to provide greater confidence in the DOC.

First, a DOC is presented to a payee (step 72). As described herein, the DOC is a digitally originated check fully compliant with existing Check 21 clearing methods. The DOC can be presented to the payee in either electronic (e.g., as an Image and Cash Letter file) or paper (e.g., as a substitute check). The payee identifies a unique transaction identifier associated with the DOC (step 74). This unique identifier can be the GUID or some other unique transaction ID. The payee inputs the identifier into a verification system (step 76). For example, the verification system can include a telephone number with Interactive Voice Response (IVR), an electronic system connected over a network, and the like. Optionally, the payee can input an identifying code along with the identifier such that the verification system can track who is verifying the DOC.

The verification system is connected to or included with the EPS described herein. Once the identifier is input, the verification system provides the validity status of the DOC (step 78). The verification system looks up the DOC based on the identifier and provides a determination of whether it is valid or not. Additionally, the verification system can also add payee, amount, or other metadata associated with the DOC for an extended verification service. Advantageously, the verification mechanism 70 provides payees greater confidence in accepting electronic payments, such as DOCs, despite the associated security vulnerabilities associated with electronic versus paper items.

This offline verification prevents fraud by allowing the payee to verify the content of a DOC at the time they receive it to prove that the item has not been altered. This feature is different than “remote” payment verification like 1-800-Che-ckme type services. This “local” method uses information within the digital file or on the paper check to verify the integrity of the content without the need to validate through an external source. For example, a PKI or signature is stored in a barcode or it could be a simple checksum via the GUID/Check ID. For example, hash all metadata down to some simple value, and record as a checksum on the check image, some type of local software application, or a “bingo card” (on the check stub) or offline “fob” service could be used to verify that the checksum was valid. The EPS could offer a publicly available one-way decoder for the hash algorithm used to decode content of a printed check or IRD. It could also include software to connect to a bar code reader to scan the barcode and retrieve metadata used in the hash. It can also use truncated hash result included in MICR line to checksum the text or numbers. This is easier for banks to read and perform as they scan MICR lines already today.

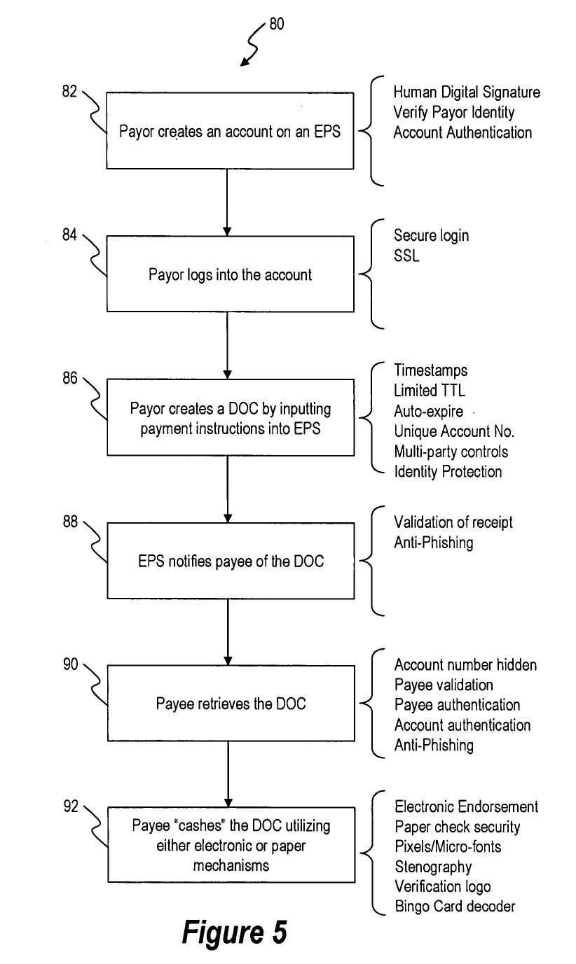

Referring to FIG. 5, a flowchart illustrates an exemplary DOC system 80 with associated security mechanisms according to an exemplary embodiment of the present invention. First, a payor creates an account on an EPS (step 82). As described herein, the EPS is an electronic payment system configured to generate, distribute, track, clear, etc. electronic payments, such as DOCs under Check 21. At step 82, the DOC system 80 can include numerous security-related mechanisms, such as a human digital signature, verification of payor identity, account authentication, and the like.

The EPS can be configured to receive a digital human signature from the payor for use on a DOC. For example, the human signature on the DOC could be restricted to a special file that is created by banks using hardware at their branch offices, and correspondingly stored in the EPS. The payor walks into a bank and authenticates herself (i.e., opening a DOC account) and one of the steps would be to “sign” either a paper form or an electronic signature capture pad. The output of which would be a specially encrypted file that was the “digitized” human signature that could be applied to a DOC as the only valid authorization required for a DOC. The human signature file is uploaded to their DOC account service and applied whenever a DOC is created. Additionally, this could be utilized in automated endorsements and auto-franking features to provide the graphic used to display human signature in images.

In an exemplary embodiment of the present invention, only parties registered with the EPS or electronic check printers (e.g., banks or Harland type check printers) can create DOC accounts or enable them to be created. This feature is similar to the idea of how you receive paper checks today, i.e. you go to your bank to authenticate yourself and request that Harland, for example, print more paper checks for you. Harland only responds to requests from the bank to create new checks with a specified account number. You do not create your own paper checks, and this could also apply with DOCs. This provides an additional level of security with a “chain of custody” in the request to create a DOC account only coming from authorized parties who can inspect the users in person and validate their identifies, such as read their drivers license, for example. This provides the highest level of “locked down” account creation security for the EPS, i.e. random users are not allowed to open an account over the Internet, they must go in person into a branch to open up a DOC account or add that service to their existing account.

With regards to account authentication, this feature only permits DOC creation (check issuing) if the payor has authenticated both themselves, such as via PKI security, and a valid Direct Deposit Account (DDA). When initially setting up a DOC account, the EPS service uses a two step process: first, the issuer is authenticated using a DOC PKI security creation process, and, second, issuer's bank account information is authenticated. The EPS pings the existing checking Demand Draft Account (DDA) account to verify you gave them a valid and correct account to draft.

Similar to ordering checks, the bank notifies a printer via a secure channel to prevent random creation of checks. The EPS could do a similar security feature, in order to have an account that creates DOCs you must go to your bank and validate yourself. At validation time, the bank could give you a PIN number to retrieve an online PKI “key pair” ID, i.e. the validation not only enables the account for DOC creation it also creates a PKI pair and provisions the user to receive their private key which is stored on their PC and used to issue DOCs online with a signed hash. This in-person validation makes the PKI infrastructure more valuable to everyone, users, banks, merchants.

In order to create a DOC, the payor logs into the account (step 84). Here, the EPS can provide several layers of security. First, the payor can utilize login and password credentials. Further, these can include a digital security ID with the login to prevent unauthorized logins. This digital security ID provides a key which is physically present with the payor, and in which the payor utilizes to log in with. Further, the EPS can utilize various other secure login mechanisms, such as security questions, picture identification, thumbprint, and the like. Additionally, the EPS can communicate over SSL and other secure networking mechanisms.

To create a DOC, the payor inputs payment instructions into the EPS (step 86). Here, the EPS can utilize various security mechanisms, such as Timestamps, Limited Time-to-Live (TTL), Auto-expire, Unique Account number, Multi-party controls, Identity Protection, and the like. Of note, step 86 is where the payor is physically creating the DOC and the associated DPF representing the DOC. With regards to timestamps, the EPS is configured to include a timestamp and details of the actions associated with the DOC creation in the step. For example, the audit information in the DPF associated with the DOC can include when the DOC is generated, an IP address of where the payor was located, and any other germane details.

The EPS account which generates a DOC could have a limited “Time to Live” (TTL). This TTL value restricts the user or software systems ability to generate digital checks using an auto-expire feature (i.e., similar to limited use accounts). For example, the account is disabled after X days so that it can not originate any more digital checks. In concept, this is like having your paper checks re-issued each year but on new “check stock” with a new account number each year. Thus, stealing checks from one month would not effect the DOCs you issue next month because there is different “account data” associated with the new DOCs and the old account is disabled. By analogy, imagine a check printer like Harland or Deluxe offering check stock which would auto-disintegrate or auto shred themselves after a certain amount of time. This security feature keeps stale “digital check stock” from being used past its intended useful life. The EPS can offer a bank an online service to control account creation/management, maintenance, customer support, etc. and ensure that each year a DOC account is renewed and re-validated—this is their value to the bank.

Also, when generated, a DOC can have an additional “payment control” which says that the DOC can only live for X days or hours or minutes, i.e. a predetermined time period. Similar to the DOC account TTL, if the TTL value expires, the individual DOC is worthless and auto-canceled. The EPS can notify the issuer that a DOC has been canceled as well so they know who was not paid. This idea eliminates the “stale check” idea. The EPS can also use a “Count Down” clock to notify the payee that they only have X time to cash the check.

Under a service provider model, the EPS could create special “sub accounts” that protect check issuers from revealing their primary DDA account number. This protects check issuer and is a security feature. The account number listed on the DOC MICR line is really an EPS-generated one time value that maps internally to the actual DDA number. To clear these checks, the user must use the EPS electronic deposit method to ensure that the “cleared” item contains the actual DDA account number. The EPS system internally substitutes the real value and sends the X9.180 file into the banking system for clearing.

Further, the EPS can utilize a Unique Account number for each DOC. Here, DOCS are issued from a one time use account which is funded for the exact amount of the check. After issuing a DOC, the individual account is closed out with zero balance. The account is closed and possibly reused in the future if needed. This prevents draining the account such as like an ACH pull can do if the wrong people get access to ACH draft information.

With regards to multi-party controls, as an added control feature on a DOC, a first party is authorized to create the DOC file (i.e., naming the payee, amount, date, Memo code, etc.) and a second party is authorized to “sign” the check, and neither party can perform the other's function and both are needed to “sign off” on a DOC before it can be sent. A third party can be used to “send” the DOC, etc. Each time, authentication is done using whatever security mechanism exists (e.g., PKI, username/password, etc). A bank department could be one of the parties, or you could go into the bank to authorize the release (e.g., sign) of the DOC. Another example is dual signatories on a check for issuers. This feature is useful for large corporations with accounts payable departments and financial controls where they care about fraud control, especially on high dollar checks. This feature allows DOCs to fit into that environment and offer the same or better features as they have today with paper checks.

Additionally, Personal information (name, address, DDA account number, etc.) used to create and process a DOC transaction is kept by EPS and not released to the merchant to protect the personal information of the buyer. Here, the GUID is used as a substitute for the customers account number, so merchants must refer to GUID to dispute or inquire about the transaction. Privilege security (e.g., government requests) could be required to see the actual customer's personal data to comply with AML rules etc.

After creation and based on a predetermined scheme, the EPS notifies the payee of the DOC (step 88). The notification can include a variety of mechanisms, such as email, fax, instant message, text message, phone call, and the like. In the case of an electronic transmission, the EPS could ping the recipient payee to request a response for validation. For example, before sending a digital check (image or DOC), the EPS could “ping” the recipients email address with a notification message, asking them to reply to the message to a well known address. The header of the returned email would be inspected and the path recorded. Then a message is sent saying that the check is waiting and a second reply must be sent to verify the recipient (looking at the return header to see if the same path was taken), only after the two email pings were sent and returned and verified, is the actual URL sent to the recipient to retrieve the check. This works well for low value checks or where the risk of fraud is low in lieu of expensive PKI security methods.

For anti-phishing, the EPS could offer a user to download and run a “GUID Decoder” application that serves both for account access and for encryption and decryption of DOC messages sent to the user through email. For example, when the client receives an email from the EPS system, they are notified in some unique way using this tool which verifies that the message is authentic communication and from the EPS, and thus they have a valid DOC. This can include a custom Multipurpose Internet Mail Extensions (MIME) type where the client app registers to handle this MIME type, and is called/loaded whenever an email is received that contains this custom MIME in the email body. The EPS can embed this special MIME type data into the email notification that the payee has a check waiting for them to retrieve. Advantageously, this helps everyone trust that they are not being phished or farmed by hackers with spoofed email messages claiming to be a DOC if they log in and provide their credentials.

Additionally with notification, the EPS service can offer the payor to send certain sensitive security data (e.g., PIN) via an alternate delivery mechanism to ensure that email eavesdropping does not compromise DOC security. If hackers intercepted an email including a DOC with PIN information, they would have full authorization to deposit the DOC. This way, a separate channel (e.g., fax, IM, phone, pager, etc.) is used to send authentication data used to cash the check.

Using data tracking and environment monitoring features, an email service could verify that there was a high probability that the recipient of an email was the intended user of their system (by verifying the path they use to retrieve the email and the patterns of behavior). This creates a “low tech” /high data tracking security feature that could be useful for service providers to have if they wanted to charge a premium for secure delivery of email or “return receipt” type features to verify the recipient did receive the email.

After notification, the payee retrieves the DOC (step 90). This step can utilize numerous security mechanisms, such as hiding account numbers, payee validation, payee authentication, account authentication, and the like. In this step, the payee can also physically log in the EPS system as well utilizing the same mechanisms described herein with respect to the payor. Also, the DOC could be sent to the payee as an image file (X9.140 compliant), and this image could include further security mechanism described herein.

The “account number” on a DOC does not have to correspond to the actual DDA account number (unlike ACH which requires the DDA account to process a payment). This allows a user to hide their personal checking account number and use an EPS-generated proxy number in its place. This proxy could be a hash of a GUID, or some other transaction ID number that is unique to that check, but which can be mapped back to the original user/DDA account. The EPS can also use “window blinds” to cover (i.e., X out) the account number in an image (e.g., sent via email) so that the image is not used fraudulently. Window Blinds help with the check statement issue, if checking account statements show images, you can get account number info—redacting from online image hides the payors account number. Only banks and the payor (after the check is returned) can view sensitive information. The EPS can encrypt the “face of the check” data, so it is only viewable by authorized users. Otherwise, the image is randomized text/junk so it is not useful if intercepted electronically. This could require a client app to “decode” the encryption and produce a useful/viewable DOC/IRD.

Unlike paper check clearing (where the payor can see where you deposited their check by inspecting the stamps on the back of the check), the EPS can hide the payee's depositing info from the payor. This provides online identity protection from fraud, etc. This security feature can be utilized when the DOC is cleared digitally and not as a paper IRD. A payee's hand signature is not revealed if the payee chooses not to use the auto-franking features. DOCs provide an additional level of de-identification so personal data does not leak out to others.

The EPS could offer a special software “viewer” to allow payees to read DOCs. A Java Plug-in can be built to communicate securely via PKI and retrieve encrypted DOC images/IRDs and present them on a computer. This feature may be required for high-security environments (e.g., government or businesses) to view/generate DOCs. The client code can also talk remotely to an accounting system and provide extra security on check issuance and audit controls. The “home user” market probably does not need this, i.e. a secure webpage is enough for them.

Finally, the payor “cashes” the DOC utilizing either electronic or paper mechanisms (step 92). Here, the payor has the option of clearing the DOC under Check 21 and the UCC as either a paper item (e.g., substitute check compliant to X9.140) or as an electronic item (e.g., an Image and Cash Letter File compliant to X9.180). Using either mechanism, the present invention can utilize electronic endorsement authentication as a security feature. With regards to a substitute check, the present invention can utilize paper check security, pixels/micro-fonts, steganography, a verification logo, a bingo card decoder, and the like.

For electronic endorsement, after notifying the payee that they have a DOC waiting for them, the EPS can require them to use the PIN number sent by the payor to retrieve the check. This means that the PIN number is used for verification that the payee is authentic before the check can be negotiated. One method is to use a pin number created by the payor. Other methods include external authentication with public records such as driver's license look-up, etc. The DOC file will store all this information at creation time and log that valid information was provided at deposit/printing time to close the payment record.

For a printed check from the DOC, the EPS is configured such that DOCs can mimic existing padlock security features found on paper checks. For example, the digital image could offer features such as micro-printing, water marks, background copy/scanning protection (VOID) etc., all embedded in the X9.180 image. This feature could translate onto the IRD as well.

Additionally, certain pixel abnormalities can be placed in obscure locations which normally appear random or as noise but are actually security codes. Of note, these bits do not exceed the “noise” requirements under the X9 specifications. Since these bits occur within the dynamic information on the check such as the text and numbers, a forger may have a hard time spotting and replicating them. Further, these bit patterns can change depending on the check group or from check to check. Trusted sources such as banks and check cashing operations could be given the decipher information. If using micro fonts, the font combination and font sequence can change (like above) according to make up of the check. Ratio of pixels to noise must be lower than Fed IQA standards. The check image must be read digitally (not scanned) and compared to a pattern matching algorithm—can not be Item Processed and verified—too much noise introduces errors.

Steganography (i.e., hiding data within images) can be used as an additional security feature for digital checks and check 21 documents. Check issuers can select a number or “text based” key phrases that can be silently “blended” into a check image using unused bits of the graphic (JPG, TIFF, etc.) file format (note, the bandwidth of these files has many extra bits). The image can then be sent electronically and decoded (receivers would assume it was just a picture or graphic from a website) but in fact it could be decoded using some algorithm to verify that the receiver was the intended receiver by the check issuer. For example, logging online a user can select one of a number pre-selected images and a “challenge phrase” (text or number) can be presented to verify that both the person logging in is the correct person and also, with the correct phrase sent back for the correct image, the login user knows that the site is legitimate and not a fake. The correct pass phrase is silently embedded into the login image so selecting a picture generates its own challenge pass phrase.

Similar to existing paper check “Padlock” icon feature, this logo graphic could indicate multiple things in a dynamic logo due to the online/Internet method which can update the “look” or image to display current state. The Multi-State picture or “bug” or logo could show security validation things like verification that the checking account exists (a valid DDA account) using some visual indicator like an open/closed padlock, it could be filled in solid green for good, red for bad, etc. The lock image could be “empty” for an unverified state, etc. This could be a shared infrastructure service or could be a value added feature for DOC issuers like Harland, Deluxe etc.

Further, to decode a DOC hashed security value, we could print the “bingo card” decoder onto the check IRD “stub”. This could be done per check, not per account. The bingo card is used to verify the account following mechanisms known in the art, such as by Entrust etc.

Tamper-proof features are provided due to DOC being in electronic form. Encrypted, PKI electronically signed through the EPS's Certificate Authority (CA), attested and non-reputable, etc. This requires a trusted authority (such as Deluxe, Harland, Verisign, etc.) to stand up and state that elements of a DOC are true or have occurred. Part of the audit trail, history and tracking features, i.e. some third party can attest to the security and reliability of the state of a DOC.

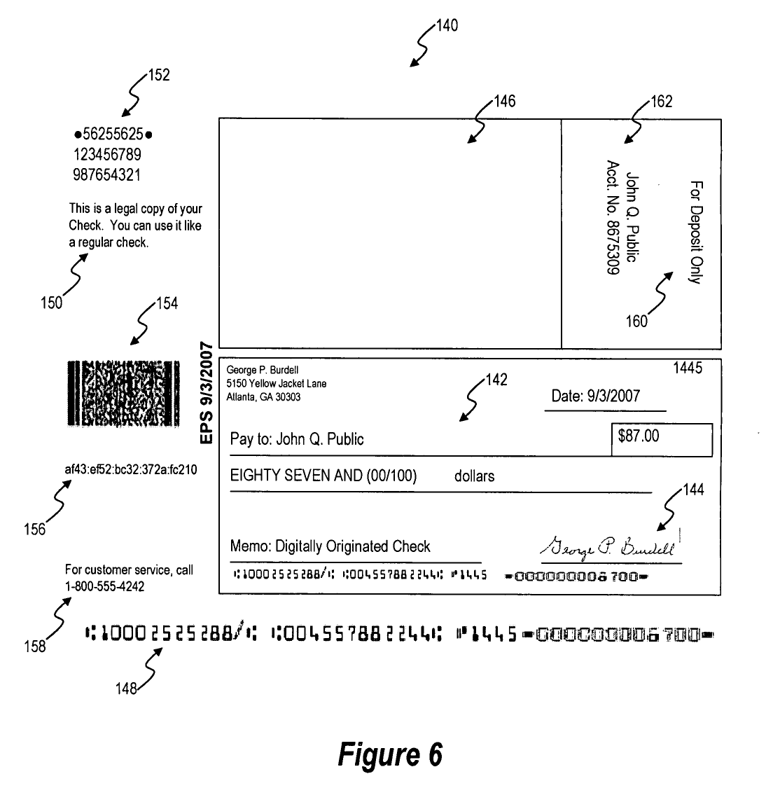

Referring to FIG. 6, a generated DOC image 140 is illustrated according to an exemplary embodiment of the present invention. While the DOC can be transmitted electronically, it can also be used to generate the X9.140 standard “substitute check” or IRD which results in a paper version of the original digital check. The IRD can be printed by the payee and taken into their bank for deposit because it contains a full set of warranties and indemnities based on the original contract agreed to by the payor and payee which the EPS required to be signed in order for the DOC to sent or received. Because DOCs are covered under this contract, they have a full set warranties and indemnities that are acceptable to both banks of deposit and downstream clearing banks. This DOC feature of possessing a “full warranty” state differs from other attempts by either businesses or individual consumer users who want to print their own IRD documents and deposit them at a bank because those documents will not be accepted by the bank of first deposit due to the depositing bank's inability to take on un-transferable risk from an unknown originator of the IRD.

The DOC image 140 is formatted similar to a standard X9.140 IRD including a standard check front 142 with a digital signature 144 and a standard check back 146. Additionally, the image 140 includes a Magnetic Ink Character Recognition (MICR) line 148 and a legal legend 150 as required by Check 21. Further, the DOC image 140 can utilize the X9.140 “optional data” area to include routing information 152 associated with the EPS, a two-dimensional barcode 154 to facilitate faster processing and security, a GUID 156, and customer service information 158. The routing information 152 can be used by itself or in conjunction with the GUID 156 to allow the EPS to track and perform other functions with the DOC image 140. The barcode 154 can be used in conjunction with a barcode reader to read all of the information associated with the DOC image 140. The GUID 156 provides the unique transaction ID associated with the DOC image 140 and the corresponding DPF. Finally, the information 158 can be used by banks and others to assist with issues or questions related to the DOC image 140.

The GUID 156 is a large, algorithmically generated, unique number. The mechanism uses a given a set of inputs as seed values and then generates a 16-byte (128-bit) number which is generally considered to be unique among all users at any time, everywhere on the planet. Using GUIDs 156 as either hidden or visible check numbers ensures that the EPS knows which DOC has been issued, cleared, etc. and facilitates tracking the check anywhere, anytime, electronically or by IVR (phone) or human lookup. This is unlike pre-printed check numbers as they are generated on the fly at DOC creation time. A GUID 156 can also serve as a Transaction ID (Tx) to find/locate a specific check within all the checks. GUIDs 156 can also be captured and stored inside the PDF417 barcode embedded on an IRD or check image for automated IRD processing.

The present invention provides DOC images 140 with superior quality and characteristics. Using a traditional scan of a paper check, a high speed reader/sorter machine takes a picture of the front and back of a check. Several errors are introduced during this mechanical paper handling process which impact further electronic processing of the image and subsequent Check 21 item. Due to inherent mechanical and optical system design defects, any mechanical paper handling process is subject to jams, miss-feeds and misalignments of the paper which result in either missing images or bad quality images (blurry) or miss-aligned images (alignment measured as degrees off or away from a horizontal axis—called skew). The impact of these scanning flaws, while rare on a percentage basis, occur so frequently in the huge volume of paper checks that the Federal Reserve system has mandated the adoption of an “Image Quality Assessment” (IQA) test before they accept and process a set of Check 21 images from any bank. Thus the IQA tests are designed to identify and reject images which do not conform to both the Check 21 standard overall as well as the specific “readability” or “legibility” OCR tests that the banking industry has agreed are minimum image requirements.

The digital generation of the DOC image 140 creates none of the traditional paper image quality errors. Second, because there is no paper item to scan, there is no resulting image skew from a non-existent horizontal axis based on the edge of the paper. The DOC image 140 is always generated with zero degrees of skew in the image. Next, the DOC image 140 has perfect image quality as measured by industry standard Image Quality tests which is independent of dpi resolution due to the fact that a pure black and white bitmap is generated from metadata and not from a scanned paper item (which results in noise being introduced by the surface of the paper item). With the DOC image 140 there are no stray black noise elements, only the exact letters, numbers, fonts, and graphics which are present. The metadata instructions generate individual black bits in the bitmap. Because the DOC image 140 files have perfect image quality (pure black and white with no random image noise), and have zero degrees of skew (i.e. they are perfectly aligned to the horizontal axis of the image file), they are always readable by both humans and computers using the lowest dpi image resolution form of Check 21. Thus, this enhanced readability reduces the chances of OCR errors of the Courtesy Amount Recognition (CAR) and Legal Amount Recognition (LAR) fields if the check image is scanned by banks who still handle paper IRDs. Finally, the well known industry problem of background image “interference” (this generically is called the “puppy and kitty” problem due to the wide spread existence of these type of background images on many consumer checks) is also avoided because the DOC image 140 does not contain any background data.

Further, current Item Processing, check sorting, and encoding methods require the imaging system to validate and compare the Courtesy Amount box with the Legal Amount field and use OCR to determine the Amount to Pay. These algorithms are not perfect and they can mistake a handwritten “7” for a “1” for example. These are called substitution errors and banks want to keep these below 1% (1 out of 100 checks have the wrong amount encoded on the MICR line). Having OCR errors forces banks to keep human operators around to compare by hand these amounts and correct these errors. DOCs images 140 are generated from digital instructions, so if they person types a “7” they get the image of a “7” on the digital check image.

Because a DOC is generated from metadata, it can be generated in many forms. First, the DOC image 140 can be generated in many resolution levels (measured as dots per inch or dpi) which are independent of the chosen bitmap format, such as JPEG, TIFF, PNG, and the like. Second, when the DOC image 140 is generated by the EPS, it can be generated to include optional data such as human signatures for easier processing in paper form. This optional or conditional data (on the front or back) can include instructions from the payee or depositing bank about depositing or clearing features of the specific payment. Examples of this include merging a “human digitized signature” 144 as the authorized signature directly into the back (or front) image of the check, even though it was never printed or signed (using the e-signature laws). Note that this “digitized signature” feature works if the payor or payee has uploaded samples of their human signature or other handwriting samples (ex. Agreed and Accepted), or they could choose to use a font that displays in “handwriting” format to simulate their human signature—any of these could satisfy the e-signature law as their authorized legal signature. Another example includes a “for deposit only” style stamp 160 for the back of the check, an account number for the deposit 162, or other contractual restrictions (such as agreement to a contract if the check is deposited) that are required by certain business processes or agreements. Thus, the image 140 form of a DOC file can contain valuable, optional data in both machine and human readable form without requiring paper processing. This further automates the processing and handling of checks and speeds up the overall business process between payor, payee, and the banking system.

The DOCs are created from “instructions to pay” in the DPF which are similar in features to a “vector image file” vs. a “raster image file”. The benefits of using metadata (like the equations describing a vector) to generate a DOC image is that it provides flexibility in how the image 140 is generated. For example, under X9 standards a Check 21 image is required to be a Black and White (B/W) 200 by 240 dots per inch TIFF image. Using the DOC invention, the EPS can generate DOC images 140 in a variety of formats such as small X9 B/W images which reduces the file size of a DOC or as a high resolution JPEG images using a grayscale format for enhanced readability or clarity. Dynamically creating the “check image” gives you flexibility and choices which are suitable to the requirements of the final use or format. Thus for storage, a DOC image can be made as small as possible given the amount of check data that must be displayed. This is useful for banks storing large numbers of check images. Additionally, the DOC image 140 can include low resolution image versions for creating IRDs and high resolution used for customer statement presentment or online viewing. An EPS can also produce DOC images at whatever resolution (or format—TIFF, JPG, PNG, etc.) is needed by the requesting system for storage or printing. The DOC record, i.e. DPF, does not contain an image, only instructions to pay, thus any image type can be generated on the fly as needed. Also, the DOC record is very small (e.g., 400 bytes vs. 400 kilobytes for an image) which can be stored very inexpensively and converted into larger formats for different purposes. This eliminates the need for banks to use a check image storing service such as ViewPoint. Instead, when needed in the future, the DOC image can be pulled back into the bank to be used for customer statement processing, dispute resolution or legal evidence, etc.

Similar to “electronic endorsement” features, using metadata and other digital technologies, any bank department or receiver of the DOC can automatically sign or endorse the check for processing and clearing after the DOC is deposited. This idea covers the bank stamps, time stamps and automation tracking features used to update the Check 21 item throughout its lifecycle. Using these concepts, the EPS can generate an image showing who signed the check, when it was deposited, how it was deposited and how quickly it was cleared, or clearly notify a payee that the item is an item returned under NSF rules, etc. The EPS updates the audit trail in the database of DOC history. The generation of multiple image forms utilizes a concept of an “image overlay” to add layers of digital stamping to the back of a check. This is not manipulation of the existing image, but instead generating each stamp in its own image layer one at a time by providing an “image overlay” layer on top of the existing DOC back of check image 146. Note that at DOC creation time, the back of a DOC image 146 is a blank image of a check back. Other unique elements of this feature are the idea of having room for “more than one” signature when multiple endorsements are needed or used, such as a third party check turned over at store. Only the last signature is shown of back of check image 146, others are kept on file in metadata, or a statement can be added saying “signature is on file” and produced as needed. The same idea can apply to bank processing of DOCs, their “stamps” can be digitally added and only the last one is shown if desired or if no room or if illegibility would be created by stamping over top of each other. For example, the most recent image can be kept in the display, but all other images are on file. Also useful for NSF checks to explain why was it returned. Check 21 provides for items returned as NSF, but the present invention makes it clear to all parties what occurred and when no matter how many back and forth attempts were made to cash the check. Another benefit is the franking features are always clear and readable, thus there is no need for a “high resolution” image of the back of the check.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A method for securing digital payments, comprising:
authenticating a payor comprising a verification of the payor's identity;
creating a digital payment responsive to payment instructions from the payor, wherein the digital payment comprises security mechanisms, a globally unique identifier, and payment instructions;
notifying a payee of the digital payment;
providing the digital payment to the payee through secure transmission mechanisms; and
cashing the digital payment.

2. The method for securing digital payments of claim 1, further comprising:
inputting the globally unique identifier into a verification system; and
receiving a validity status of the digital payment from the verification system, wherein the verification system is configured to look up and retrieve the status of the digital payment responsive to the identifier.

3. The method for securing digital payments of claim 1, wherein authenticating the payor further comprises receiving a physical human signature from the payor.

4. The method for securing digital payments of claim 1, wherein the security mechanisms comprise an audit timestamp and associated description of activity, a limited time-to-live, an auto-expire timer, and combinations thereof.

5. The method for securing digital payments of claim 1, wherein the security mechanisms comprise a unique account number for each digital payment, wherein the unique account number comprises an account funded with exactly the amount of the digital payment, and wherein the account is closed following the cashing step.

6. The method for securing digital payments of claim 1, wherein notifying the payee comprises an electronic message, wherein the electronic message comprises security configured to prevent phishing comprising and a receipt validation mechanism operable to verify receipt of the message.

7. The method for securing digital payments of claim 1, wherein the secure transmission mechanism comprise hiding an account number of the payor, validation of the payee, authentication of the payee, and combinations thereof.

8. The method for securing digital payments of claim 1, wherein cashing the digital payment comprises one of:
electronically forwarding the digital payment as an Image and Cash Letter file compliant to Check 21 to a bank of first deposit; and
endorsing and printing a substitute check compliant to Check 21 and presenting the substitute check to one of a bank of first deposit and another payee.

9. The method for securing digital payments of claim 8, wherein the substitute check comprises any of:
micro-printing, water marks, background copy/scanning protection, and combinations thereof;
pixel abnormalities comprising security codes, wherein the pixel abnormalities are placed in obscure locations which appear as random noise;
steganography comprising hidden security data within images of the substitute check;
a verification logo;
a hashed security value requiring a bingo card decoder to decode; and
combinations thereof.

10. The method for securing digital payments of claim 1, further comprising receiving authentication approval from both the payor and payee prior to providing the digital payment.

11. A secure method for receiving a digital payment, comprising:
receiving a notification of a digital payment, wherein the notification comprises one of an electronic notification and a paper item comprising a Check 21 compliant substitute check printed from the digital payment;
retrieving the digital payment if the notification comprises the electronic notification;
determining a globally unique identifier associated with the digital payment, wherein the globally unique identifier is located in the notification;
inputting the globally unique identifier in a verification system; and
receiving a status of the digital payment from the verification system, wherein the status comprises validity of the digital payment.

12. The secure method for receiving a digital payment of claim 11, wherein the electronic notification comprises a personal identification number (PIN) provided in a separate transmission from the digital payment, and wherein the PIN is utilized in the retrieving step for authentication.

13. The secure method for receiving a digital payment of claim 11, further comprising depositing the digital payment utilizing existing Check 21 clearing methods comprising one of electronically forwarding the digital payment as an Image and Cash letter file to a bank and printing the digital payment as a substitute check.

14. A method for providing a secure image of a digital payment, comprising:
receiving payment instructions;
formatting the payment instructions in a secure digital payment file;
generating a secure image from the payment instructions, wherein the secure image comprises security configured to prevent tampering and counterfeiting of the image; and
providing the secure image to a payee, wherein the payee is defined in the payment instructions.

15. The method for providing a secure image of a digital payment of claim 14, further comprising printing the image as a substitute check compliant to Check 21 X9.140 standards.

16. The method for providing a secure image of a digital payment of claim 14, wherein the security comprises any of micro-printing, water marks, background copy/scanning protection, and combinations thereof embedded in the secure image.

17. The method for providing a secure image of a digital payment of claim 14, wherein the security comprises pixel abnormalities comprising security codes, wherein the pixel abnormalities are located in the secure image to appear as random and noise.

18. The method for providing a secure image of a digital payment of claim 14, wherein the security comprises steganography comprising hidden data within the secure image, and wherein the steganography is configured to be decoded by the payee.

19. The method for providing a secure image of a digital payment of claim 14, wherein the security comprises a dynamic logo embedded in the secure image, wherein the dynamic logo is operable to change responsive to a state of the digital payment.

20. The method for providing a secure image of a digital payment of claim 14, wherein the security comprises an electronic signature.
